(19) United States
(12) Patent Application Publication
(10) Pub. No.: US 2023/0220200 A1
(43) Pub. Date: Jul. 13, 2023

(54) POLYMER COMPOSITION FOR WATERPROOF-BREATHABLE FILMS

(71) Applicant: ARKEMA FRANCE, Colombes (FR)

(72) Inventor: Clio COCQUET, Serquigny (FR)

(73) Assignee: ARKEMA FRANCE, Colombes (FR)

(21) Appl. No.: 17/914,380

(22) PCT Filed: Apr. 7, 2021
(86) PCT No.: PCT/FR2021/050607

§ 371 Date: Sep. 26, 2022

(30) Foreign Application Priority Data
Apr. 7, 2020 (FR) 2003472

(51) Int. Cl. C08L 75/08; B29C 48/08; C08J 5/18; C08L 67/02

(52) U.S. Cl. CPC C08L 75/08; B29C 48/08; C08J 5/18; C08L 67/02; C08L 2203/16; C08J 2367/02; C08J 2375/08; B29K 2075/00

(57) ABSTRACT

The invention relates to a composition consisting of 75 to 98 wt %, relative to the weight of the composition, of at least one hydrophilic elastomeric thermoplastic polymer (TPE) A selected from (a1) copolymers containing polyester blocks and polyether blocks, (a2) copolymers containing polyurethane blocks and polyether blocks or polyester blocks and/or mixtures thereof; 2 to 15% by weight, relative to the weight of the composition, of at least one copolymer B comprising units derived from ethylene, from an alkyl (meth)acrylate and from a comonomer comprising at least one acid, anhydride or epoxide function; and 0 to 10% by weight, relative to the weight of the composition, of at least one additive. The invention further relates to a process for manufacturing a film and to said film.

### FIELD OF THE INVENTION

The present invention relates to a polymer composition and also to a waterproof-breathable film obtained using said composition.

### TECHNICAL BACKGROUND

Films that are impermeable to liquid water and permeable to water vapor are used in various fields such as textiles, construction, agriculture, packaging, etc. These films may be used, for example, as packagings for covering articles or as coatings adhered to the surface of articles.

In general, breathable films must meet certain requirements such as a homogeneous appearance, wind resistance, high permeability to water vapor, a certain elasticity, as well as a capacity for adhering to different substrates. In addition, these films must be readily processable during production, notably by extrusion, without causing deformations in the film. Poor processability is reflected by imperfections on the films, such as holes or irregular edges.

It is known practice to use compositions comprising containing polyamide blocks and polyether blocks in order to form such films. However, despite a high permeability to water vapor, the films formed are sparingly stretchable, which causes problems during their manufacture by extrusion, notably by extrusion coating.

Moreover, the use of terpolymer compositions, notably terpolymers derived from ethylenic, acrylic and butylenic monomers, makes it possible to obtain films that can be readily processable by extrusion. However, these films have very low breathability.

US 2004/0 029 467 relates to a breathable film which comprises at least one polymer (a) chosen from the group comprising an ethylene/alkyl (meth)acrylate copolymer (a1), an optionally neutralized ethylene/(meth)acrylic acid copolymer (a2), an ethylene/vinyl monomer copolymer (a3), the mixture (a1)/(a2), the mixture (a1)/(a3), the mixture (a2)/(a3) and the mixture (a1)/(a2)/(a3), and/or which comprises at least one functionalized polyethylene (b); and at least one copolymer (c) containing copolyamide blocks or polyester blocks and polyether blocks.

U.S. Pat. No. 5,614,588 relates to a polymer blend comprising a polyether block amide consisting of 30% to 60% by weight of polyamide-12, polyamide-11 and/or polyamide-12,12 blocks and 70% to 40% by weight of polyethylene glycol blocks, a polyether block amide consisting of 65% to 85% by weight of polyamide-12, polyamide-11 and/or polyamide-12,12 blocks and 35% to 15% by weight of polyethylene glycol blocks, and a poly(ethylene-co-vinyl acetate-g-maleic anhydride) polymer consisting of 75% to 95% by weight of ethylene, 5% to 25% by weight of vinyl acetate and 0.1% to 2% by weight of maleic anhydride. The composition of said document is used for manufacturing films that are permeable to water vapor.

U.S. Pat. No. 5,506,024 relates to films that are permeable to water vapor manufactured from thermoplastic elastomers based on polyetheresteramide and preferably based on polyether block amide.

U.S. Pat. No. 5,800,928 relates to films that are permeable to water vapor comprising at least one thermoplastic elastomer comprising polyether blocks and at least one copolymer comprising ethylene and at least one alkyl (meth)acrylate.

There is a need to provide a composition that allows the manufacture of films which have both good permeability to water vapor and good processability during their manufacture.

### DESCRIPTION OF THE INVENTION

The invention relates firstly to a composition consisting of:

from 75% to 98% by weight of at least one hydrophilic thermoplastic elastomer (referred to hereinbelow as TPE) polymer A, chosen from (a1) copolymers containing polyester blocks and polyether blocks (COPE), (a2) copolymers containing polyurethane blocks and polyether or polyester blocks (TPU) and/or mixtures thereof, relative to the weight of the composition;

from 2% to 15% by weight of at least one copolymer B comprising units derived from ethylene, from an alkyl (meth)acrylate and from a comonomer including at least one acid, anhydride or epoxide function, relative to the weight of the composition; and

from 0% to 10% by weight of at least one additive, relative to the weight of the composition.

For the purposes of the present invention, the copolymers containing polyester blocks and polyether blocks (referred to hereinbelow as COPE or copolyetheresters) are copolymers containing polyester blocks and polyether blocks. They consist of flexible polyether blocks derived from polyetherdiols and rigid polyester blocks which result from the reaction of at least one dicarboxylic acid with at least one short chain-extending diol unit. The polyester blocks and the polyether blocks are linked via ester bonds resulting from the reaction of the acid functions of the dicarboxylic acid with the OH functions of the polyetherdiol. The linking of the polyethers and the diacids forms the flexible blocks whereas the linking of glycol or butanediol with the diacids forms the rigid blocks of the copolyetherester. The short chain-extending diol may be chosen from the group consisting of neopentyl glycol, cyclohexanedimethanol and aliphatic glycols of the formula HO(CH₂)ₙOH in which n is an integer from 2 to 10.

Advantageously, the diacids are aromatic dicarboxylic acids containing from 8 to 14 carbon atoms. Up to 50 mol % of the aromatic dicarboxylic acid may be replaced with at least one other aromatic dicarboxylic acid containing from 8 to 14 carbon atoms, and/or up to 20 mol % may be replaced with an aliphatic dicarboxylic acid containing from 2 to 14 carbon atoms.

As examples of aromatic dicarboxylic acids, mention may be made of terephthalic acid, isophthalic acid, bibenzoic acid, naphthalenedicarboxylic acid, 4,4′-diphenylenedicarboxylic acid, bis(p-carboxyphenyl)methane, ethylenebis(p-benzoic acid), 1,4-tetramethylenebis(p-oxybenzoic acid), ethylenebis(p-oxybenzoic acid) and 1,3-trimethylenebis(p-oxybenzoic acid).

As examples of glycols, mention may be made of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedimethanol. The copolymers containing polyester blocks and polyether blocks are, for example, copolymers containing polyether units derived from polyetherdiols such as polyethylene glycol (PEG), polypropylene glycol (PPG), polytrimethylene glycol (PO3G) or polytetramethylene glycol (PTMG), dicarboxylic acid units such as terephthalic acid, and glycol (ethanediol) or 1,4-butanediol units. Such copolyetheresters are described in patents EP 402 883 and EP 405 227. These polyetheresters are thermoplastic elastomers. They may contain plasticizers. Examples that may be mentioned include the commercial products under the names Arnitel®, sold by DSM, or Hytrel®, sold by DuPont.

For the purposes of the present invention, the copolymers containing polyurethane blocks and polyether or polyester blocks (referred to hereinbelow as TPU) are polyetherurethanes which result from the condensation of flexible polyether blocks which are polyetherdiols and rigid polyurethane blocks resulting from the reaction of at least one diisocyanate which may be chosen from aromatic diisocyanates (e.g. MDI, TDI) and aliphatic diisocyanates (e.g. HDI or hexamethylene diisocyanate) with at least one short diol. The short chain-extending diol may be chosen from the glycols mentioned above in the description of the copolyetheresters.

The polyurethane blocks and the polyether blocks are linked via bonds resulting from the reaction of the isocyanate functions with the OH functions of the polyetherdiol.

Mention may also be made of polyesterurethanes, which result from the condensation of flexible polyester blocks which are polyesterdiols and rigid polyurethane blocks resulting from the reaction of at least one diisocyanate with at least one short diol. The polyesterdiols result from the condensation of dicarboxylic acids advantageously chosen from aliphatic dicarboxylic diacids containing from 2 to 14 carbon atoms and glycols which are short chain-extending diols chosen from the glycols mentioned above in the description of the copolyetheresters. They may contain plasticizers.

According to one embodiment, the hydrophilic TPE comprises at least 10%, preferably at least 20%, preferably at least 30%, preferably at least 40%, preferably at least 50%, by weight of polyethylene glycol (PEG) relative to the weight of the TPE.

According to certain embodiments, the alkyl (meth)acrylate includes an alkyl group comprising from 1 to 24 carbon atoms, and preferably from 1 to 5 carbon atoms.

According to certain embodiments, the alkyl (meth)acrylate is chosen from methyl (meth)acrylate, ethyl (meth)acrylate, and butyl (meth)acrylate and also combinations thereof.

According to certain embodiments, the molar content of units derived from alkyl (meth)acrylate in copolymer B is from 5% to 35%.

According to certain embodiments, the molar content of comonomer including at least one acid, anhydride or epoxide function in copolymer B is from 0.1% to 15%.

According to certain embodiments, the comonomer including at least one acid, anhydride or epoxide function is chosen from unsaturated carboxylic acid anhydrides, and preferably is maleic anhydride.

According to certain embodiments, the comonomer including at least one acid, anhydride, or epoxide function has an unsaturated epoxide function, and preferably is glycidyl methacrylate.

According to certain embodiments, copolymer B is free of units derived from vinyl acetate.

According to certain embodiments, the additive is chosen from inert dyes such as titanium dioxide, fillers, surfactants, crosslinking agents, nucleating agents, reactive compounds, mineral or organic flame retardants, ultraviolet (UV) or infrared (IR) light absorbers, UV or IR fluorescent agents, and also combinations thereof.

The invention also relates to a process for manufacturing a film using the composition described above.

The film according to the invention may be prepared via any method that makes it possible to obtain an intimate or homogeneous mixture containing said hydrophilic TPE and a copolymer B according to the invention, and optionally one or more additives, such as melt compounding, extrusion, compacting or else a roll mill.

According to one embodiment, the TPE and copolymer B in the form of granules can be dry-blended prior to being processed into a film.

The usual mixing and kneading devices of the thermoplastics industry, such as extruders, twin-screw extruders, notably self-cleaning gearing co-rotating twin-screw extruders, and kneading machines, for example Buss co-kneaders or internal mixers, are advantageously used.

According to a preferential embodiment, the process for manufacturing the film is an extrusion process. According to certain embodiments, the extrusion is performed at a temperature of from 100 to 300° C., and preferably from 150 to 280° C.

The process generally comprises a step of drawing the composition. The drawing step may be performed by extrusion blow-molding.

According to one embodiment, the drawing step is performed by extrusion coating.

According to one embodiment, the drawing step is performed by flat extrusion.

The invention also relates to a film obtained via the processes described above.

The present invention makes it possible to overcome the drawbacks of the prior art. More particularly, it provides a composition that allows the manufacture of films having both good permeability to water vapor and good processability during their manufacture.

This is accomplished by means of a composition consisting of at least one polymer A as described above and at least one copolymer B comprising units derived from at least three comonomers: a first ethylene comonomer, a second alkyl (meth)acrylate comonomer, and a third comonomer including at least one reactive function in the form of an acid, anhydride or epoxide group; and optionally one or more additives.

More particularly, this composition consisting of from 75% to 98% by weight of polymer A, from 2% to 15% by weight of copolymer B and from 0 to 10% of at least one additive, makes it possible to obtain films having good permeability to water vapor and very good processability, notably by extrusion, and in particular by hot extrusion.

The invention is now described in greater detail and in a nonlimiting manner in the description that follows.

### Composition

The composition according to the invention consists of:

at least one polymer A chosen from (a1) copolymers containing polyester blocks and polyether blocks and (a2) copolymers containing polyurethane blocks and polyether or polyester blocks;

at least one copolymer B comprising units derived from at least three comonomers: a first ethylene comonomer, a second alkyl (meth)acrylate comonomer and a third comonomer comprising at least one reactive function in the form of an acid, anhydride or epoxide group; and

optionally at least one additive.

Polymer A is present in the composition in a content ranging from 75% to 98% and preferably from 75% to 95% by weight relative to the weight of the composition. For example, polymer A may be present in the composition in a content of from 75% to 78%; or from 78% to 80%; or from 80% to 82%; or from 82% to 84%; or from 84% to 86%; or from 86% to 88%; or from 88% to 90%; or from 90% to 92%; or from 92% to 94%; or from 94% to 96%; or from 96% to 98% by weight relative to the weight of the composition

As regards copolymer B comprising units derived from at least three comonomers, it is present in a content of from 2% to 15%, and preferably from 5% to 15% by weight relative to the weight of the composition. For example, this copolymer B may be present in the composition in a content of from 2% to 3%; or from 3% to 4%; or from 4% to 5%; or from 5% to 6%; or from 6% to 7%; or from 7% to 8%; or from 8% to 9%; or from 9% to 10%; or from 10% to 11%; or from 11% to 12%; or from 12% to 13%; or from 13% to 14%; or from 14% to 15% by weight relative to the weight of the composition.

The first comonomer from which this copolymer B is manufactured is ethylene. The units derived from ethylene may have a molar content in copolymer B of from 50% to 94.9%, and preferably from 58% to 79%. This molar content may notably be from 50% to 55%; or from 55% to 60%; or from 60% to 65%; or from 65% to 70%; or from 70% to 75%; or from 75% to 80%; or from 80% to 85%; or from 85% to 90%; or from 90% to 94.9%.

The second comonomer from which this copolymer B is manufactured is an alkyl (meth)acrylate. The term “alkyl (meth)acrylate” refers to alkyl acrylates and alkyl methacrylates. Preferably, the alkyl group of the alkyl (meth)acrylate comprises from 1 to 24 carbon atoms and preferably from 1 to 5 carbon atoms. For example, it may comprise from 1 to 2; or from 2 to 4; or from 4 to 6; or from 6 to 8; or from 8 to 10; or from 10 to 12; or from 12 to 14; or from 14 to 16; or from 16 to 18; or from 18 to 20; or from 20 to 22; or from 22 to 24 carbon atoms.

According to certain preferred embodiments, the second comonomer is chosen from methyl (meth)acrylate, ethyl (meth)acrylate, butyl (meth)acrylate, isobutyl (meth)acrylate, 2-ethylhexyl (meth)acrylate, and also combinations thereof. Preferably, the second comonomer is chosen from methyl (meth)acrylate, ethyl (meth)acrylate and butyl (meth)acrylate.

According to certain embodiments, only one second alkyl (meth)acrylate comonomer is used to manufacture copolymer B.

According to other embodiments, copolymer B may be manufactured from more than one second alkyl (meth)acrylate comonomer, for example two or three second comonomers. For example, copolymer B may be manufactured from ethyl (meth)acrylate and/or methyl (meth)acrylate and/or butyl (meth)acrylate.

The units derived from the second comonomer(s) may have a molar content in copolymer B of from 5% to 35%, and preferably from 20% to 30%. This molar content may notably be from 5% to 10%; or from 10% to 15%; or from 15% to 20%; or from 20% to 25%; or from 25% to 30%; or from 30% to 35%.

The third comonomer includes at least one reactive function in the form of an acid, anhydride or epoxide group.

According to certain embodiments, the third comonomer is chosen from unsaturated carboxylic acids or carboxylic acid anhydride derivatives thereof, and preferably from unsaturated dicarboxylic acids or dicarboxylic acid anhydride derivatives thereof.

Examples of unsaturated dicarboxylic acid anhydrides are notably maleic anhydride, itaconic anhydride, citraconic anhydride, and tetrahydrophthalic anhydride. Maleic anhydride is preferably used.

Unsaturated monocarboxylic or dicarboxylic acid monomers such as (meth)acrylic acid may also be used.

Alternatively, the third comonomer may comprise an unsaturated epoxide type function.

Notable examples include:

aliphatic glycidyl esters and ethers, such as allyl glycidyl ether, vinyl glycidyl ether, glycidyl maleate and itaconate, glycidyl methacrylate (GMA) and acrylate; and

alicyclic glycidyl esters and ethers, such as glycidyl 2-cyclohex-1-ene ether, diglycidyl 4,5-cyclohexene carboxylate, glycidyl 4-cyclohexene carboxylate, glycidyl 5-norbornene-2-methyl-2-carboxylate and diglycidyl endocis-bicyclo[2.2.1]hept-5-ene-2,3-dicarboxylate.

The units derived from the third comonomer may be present in copolymer B in a molar content of from 0.1% to 15%, and preferably from 1% to 12%. This molar content may notably be from 0.1% to 1%; or from 1% to 3%; or from 3% to 5%; or from 5% to 7%; or from 7% to 9%; or from 9% to 11%; or from 11% to 13%; or from 13% to 15%.

According to certain embodiments, only one third alkyl (meth)acrylate comonomer is used to manufacture copolymer B.

According to other embodiments, copolymer B may comprise units derived from more than one third comonomer, for example two or three third comonomers. For example, the composition according to the invention may comprise units from maleic anhydride and from glycidyl methacrylate.

In such a case, the contents of units derived from the third comonomer are given relative to the total amount of the various third comonomers.

Preferably, copolymer B does not comprise any units derived from comonomers other than the first, second and third comonomers described above.

Preferably, copolymer B is a terpolymer, i.e. it includes units derived from only three comonomers.

Examples of preferred copolymers B are: terpolymers derived from ethylene, methyl acrylate and maleic anhydride; terpolymers derived from ethylene, ethyl acrylate and maleic anhydride; terpolymers derived from ethylene, butyl acrylate and maleic anhydride; terpolymers derived from ethylene, methyl acrylate and glycidyl methacrylate; terpolymers derived from ethylene, ethyl acrylate and glycidyl methacrylate; terpolymers derived from ethylene, butyl acrylate and glycidyl methacrylate.

Copolymer B is preferably manufactured by copolymerization of the various comonomers, notably of the high-pressure radical type. For example, the second and third comonomers may be copolymerized directly with ethylene, notably by high-pressure radical polymerization.

According to certain preferred embodiments, the composition according to the invention, and more particularly copolymer B, is free of units derived from vinyl acetate. The reason for this is that said monomer may have toxic properties. Moreover, it is not suitable for hot extrusion, which makes it difficult or even impossible to form a film from a composition comprising units derived from this monomer.

As regards the additives, they are optionally present in a weight content of from 0 to 10% and preferably from 0 to 5%. For example, one or more additives may be present in a weight content of from 0 to 0.5%; or from 0.5% to 1%; or from 1% to 2%; or from 2% to 3%; or from 3% to 4%; or from 4% to 5%; or from 5% to 6%; or from 6% to 7%; or from 7% to 8%; or from 8% to 9%; or from 9% to 10%.

These additives may include, for example, inert dyes such as titanium dioxide, fillers, surfactants, crosslinking agents, nucleating agents, reactive compounds, mineral or organic flame retardants, ultraviolet (UV) or infrared (IR) light absorbers, and UV or IR fluorescent agents. Typical fillers include talc, calcium carbonate, clay, silica, mica, wollastonite, feldspar, aluminum silicate, alumina, hydrated alumina, glass microspheres, ceramic microspheres, thermoplastic microspheres, baryte, and wood flour.

These additives makes it possible to modify one or more physical properties of the composition.

### Film

The invention also relates to a film obtained using the composition described above.

This film may preferably be manufactured by extrusion. Preferably, the extrusion is performed hot, at a temperature ranging from 100 to 300° C., preferably from 150 to 300° C., for example from 180 to 280° C.

According to certain embodiments, the film is manufactured by extrusion coating of the composition according to the invention onto a substrate. In this case, the extrusion temperature may be, for example, from 250 to 300° C. The substrate may be chosen from aluminum, paper, board, cellophane, films based on polyethylene, polypropylene, polyamide, polyester, polyvinyl chloride (PVC), polyvinylidene chloride (PVDC) or polyacrylonitrile (PAN) resins, these films being optionally oriented, optionally metallized, optionally treated by physical or chemical means, and films coated with a thin inorganic barrier layer, such as polyester (PET SiOx or AlOx) and woven or nonwoven fabrics. When the film is not a woven or nonwoven fabric, it is preferably perforated, notably micro-perforated.

According to other embodiments, the film may be manufactured by flat film extrusion (“extrusion casting”) of the composition according to the invention. In this case, the extrusion temperature may be, for example, from 180 to 230° C.

The film according to the invention is a waterproof-breathable film. The term “waterproof-breathable” means permeable to water vapor and impermeable to liquid water.

The film according to the invention may have a thickness of from 2 to 100 μm and preferably from 10 to 50 μm.

According to one embodiment, the waterproof-breathable film has a thickness of less than or equal to 50 mm, preferably less than or equal to 40 mm, 30 mm, or 25 mm, preferably between 5 and 25 mm.

A thickness as described above affords a good property in terms of permeability to water vapor.

Preferably, the film according to the invention has a permeability to water vapor (MVTR, for “Moisture Vapor Transmission Rate”) of at least 700 g/m² per 24 hours, at 23° C., at a relative humidity of 50%, for a film thickness of 30 μm. More preferably, the permeability to water vapor MVTR of the film is at least 800 g/m²/24 h, at 23° C., at a relative humidity of 50%, for a film thickness of 30 μm. In particular, the MVTR membrane permeability may range from 700 to 800 g/m²/24 h, or from 800 to 900 g/m²/24 h, or from 900 to 1000 g/m²/24 h, or from 1000 to 1200 g/m²/24 h, or from 1200 to 1500 g/m²/24 h, or from 1500 to 2000 g/m²/24 h, or from 2000 to 2500 g/m²/24 h, or from 2500 to 3000 g/m²/24 h, or from 3000 to 3500 g/m²/24 h, or from 3500 to 4000 g/m²/24 h, or from 4000 to 4500 g/m²/24 h, or from 4500 to 5000 g/m²/24 h, at 23° C., at a relative humidity of 50%, for a film thickness of 30 μm. The permeability to water vapor (MVTR) of the film, at 23° C., for a relative humidity of 50%, for a film thickness of 30 μm, may be measured according to the standard ASTM E96A.

The invention also relates to the use of a film as described in the present invention in the medical, hygiene, luggage, manufacturing, clothing, domestic or household equipment, furniture, carpet, automotive, industry, notably industrial filtration, agriculture and/or construction sectors.

The invention also relates to a laminated product (hereinbelow a laminate) comprising at least one material and at least one waterproof-breathable film according to the invention, in which the material may be chosen, for example, from textile, a building material, packagings or coatings.

According to a particular embodiment, the material is a textile material, said film adhering to at least one surface of the textile material with a peel force that is within the range from 0.5 to 50 N, preferably from 0.5 to 10 N.

Advantageously, the film according to the invention is notably applied to a textile material via any known process, preferably without using an adhesive between the film and the textile.

Examples that may be mentioned include extrusion coating of a film of the composition onto the textile, or hot pressing (thermo-lamination or lamination bonding) of the film onto a textile or between two textiles, at a temperature that is sufficient for the film to impregnate and entrap the textile fibers.

According to an alternative embodiment or an embodiment combined with the preceding one(s), mention may also be made of bonding using an adhesive seal, preferably an aqueous adhesive seal, i.e. comprising less than 5% by weight of solvent on the adhesive seal composition.

Preferably, the film has a thickness of between 5 and 50 mm, and preferably between about 5 and 10 mm. Advantageously, in an extrusion-coating application, from 10 to 50 g/m² of thermoplastic film are applied to the textile.

In the present description of the invention, the following definitions apply:

the term “textile material” or “textile” means any material made from fibers or from filaments and also any material, including paper and cardboard, forming a porous membrane characterized by a length/thickness ratio of at least 300;

the term “fiber” means any synthetic or natural material characterized by a length/diameter ratio of at least 300;

the term “filament” means any fiber of infinite length.

Among the textiles are, notably, fiber laps (dressings, filters, felt), roving (dressings), yarns (for sewing, knitting or weaving), knitted fabrics (rectilinear, circular, fully-fashioned), fabrics (traditional, Jacquard, multiple, double-sided, multiaxial, 2.5D, 3D), and many others.

According to a preferred embodiment of the invention, said at least one textile material is in the form of a porous membrane, a woven textile or a nonwoven textile.

Advantageously, said at least one textile material comprises synthetic fibers, notably synthetic fibers obtained from biobased raw materials, natural fibers, artificial fibers manufactured from natural raw materials, mineral fibers and/or metallic fibers.

Advantageously, said textile comprises synthetic fibers obtained from biobased raw materials, such as polyamide fibers, notably polyamide 11. Advantageously, said textile also comprises natural fibers, such as cotton, wool and/or silk, artificial fibers manufactured from natural raw materials, and mineral fibers, such as carbon, glass, silica and/or magnesium fibers.

The textile is notably chosen from fabrics or textile surfaces, such as woven, knitted, nonwoven or carpet surfaces. These articles may be, for example, carpets, rugs, upholstery, surface coverings, sofas, curtains, bedding, mattresses and pillows, garments and medical textile materials.

The textile according to the invention advantageously constitutes a felt, a filter, a film, a gauze, a cloth, a dressing, a layer, a fabric, a knitted fabric, a clothing article, a garment, a bedding article, a furnishing article, a curtain, a passenger compartment covering, a functional technical textile, a geotextile and/or an agrotextile.

### EXAMPLE

The following example illustrates the invention without limiting it.

Films were prepared from different compositions (A to G) in the following two ways so as to evaluate the permeability to water vapor and the stability limit (processability) of the films.

For the evaluation of the permeability to water vapor:

The films were prepared from the various compositions (A to G) via a flat film extrusion process (“extrusion casting”) using an extruder having the following parameters:

screw diameter: 30 mm;

L/D ratio: 25;

profile: screw-barrier;

die: T-shaped, 250 μm wide and 300 μm air gap.

The extrusion temperatures were between 180° C. and 230° C. and were adapted according to the grade of the copolymer.

The permeability to water vapor MVTR was measured at 23° C., at 50% relative humidity, according to the standard ASTM E96A.

The films obtained have a thickness of 50 μm.

For the evaluation of the processability:

The films were prepared from the various compositions (A to G) by extrusion coating on an aluminum (37 μm)/polymer support using a Collin extrusion coating line having the following parameters:

air gap: 70 mm;

screw speed: 80 rpm;

die gap: 300 μm.

The extrusion temperature was 280° C.

The films have an initial thickness of 50 μm (which decreases with increasing line speed).

Thus, to evaluate the stability limit of the film, the line speed was gradually increased from 5 m/min until instability was observed. This instability may be breakage of the film, one or more holes formed on the film or instability of the film width. These observations were made three times so as to confirm the results, and an average value was taken.

The film stability limit corresponds to the speed at and above which instabilities appear.

In both cases:

The terpolymers (polymers comprising units derived from at least three comonomers) used are the following:

TABLE 1

| | | 2nd monomer | 3rd monomer |
|---|---|---|---|
| Terpolymer | 1st monomer | (molar content) | (molar content) |
| Terpo1 | Ethylene | Ethyl acrylate (29%) | Maleic |
| | | | anhydride (1.3%) |
| Terpo2 | Ethylene | Butyl acrylate (25%) | Glycidyl |
| | | | methacrylate (8%) |
| Terpo3 | Ethylene | Butyl acrylate (25%) | Glycidyl |
| | | | methacrylate (5%) |

The copolymers used for comparative purposes are the following:

TABLE 2

| | | 2nd monomer |
|---|---|---|
| Copolymer | 1st monomer | (molar content) |
| Copo1 | Ethylene | Methyl acrylate (25%) |
| Copo2 | Ethylene | Methyl acrylate (30%) |

The features of compositions A to G are given in the following table:

TABLE 3

| Compositions | TPE Polymer (%) | Terpolymer or copolymer (%) |
|---|---|---|
| A (invention) | 90% | Terpo1 (10%) |
| B (invention) | 90% | Terpo2 (10%) |
| C (invention) | 90% | Terpo3 (10%) |
| D (comparative) | 80% | Terpo1 (20%) |
| E (comparative) | 90% | Copo1 (10%) |
| F (comparative) | 90% | Copo2 (10%) |
| G (comparative) | 100% | — |
| H (invention) | 90% | Terpo 1 10% |
| I (comparative) | 100% | — |

The TPE polymer used in the examples (A-G) is a commercial COPE product under the brand name Arnitel® VT 3108 sold by DSM.

The TPE polymer used in Examples H and I is a commercial aromatic polyether polyurethane product under the brand name Dureflex® sold by Covestro.

Compositions A to C and H are according to the invention and compositions D to G correspond to comparative examples (composition D comprises a copolymer B according to the invention but with a higher content than that claimed and composition G comprises only Arnitel copolymer).

The results of the permeability to water vapor and also the stability limit of the films (A to G) obtained with compositions A to are presented below:

| | Stability limit | Permeability to |
|---|---|---|
| Films | (m/min) | water vapor |
| A (invention) | 35 | 325 |
| B (invention) | 41 | 330 |
| C (invention) | 38 | 322 |
| D (comparative) | 50 | 245 |
| E (comparative) | 22 | 320 |
| F (comparative) | 23 | 315 |
| G (comparative) | 17 | 360 |
| H (invention) | 40 | 300 |
| I (comparative) | 25 | 310 |

It is observed that the films according to the invention (A to C, H) have both high permeability to water vapor and good processability (stability limit of the film).

1. A composition consisting of:
from 75% to 98% by weight of at least one hydrophilic thermoplastic elastomer (TPE) polymer A, chosen from (a1) copolymers containing polyester blocks and polyether blocks, (a2) copolymers containing polyurethane blocks and polyether or polyester blocks and/or mixtures thereof, relative to the weight of the composition;
from 2% to 15% by weight of at least one copolymer B comprising units derived from ethylene, from an alkyl (meth)acrylate and from a comonomer including at least one acid, anhydride or epoxide function, relative to the weight of the composition; and
from 0% to 10% by weight of at least one additive, relative to the weight of the composition.

2. The composition as claimed in claim 1, in which the alkyl (meth)acrylate includes an alkyl group comprising from 1 to 24 carbon atoms.

3. The composition as claimed in claim 1, in which the alkyl (meth)acrylate is chosen from methyl (meth)acrylate, ethyl (meth)acrylate, and butyl (meth)acrylate and also combinations thereof.

4. The composition as claimed in claim 1, in which the molar content of units derived from alkyl (meth)acrylate in copolymer B is from 5% to 35%.

5. The composition as claimed in claim 1, in which the molar content of comonomer including at least one acid, anhydride or epoxide function in copolymer B is from 0.1% to 15%.

6. The composition as claimed claim 1, in which the comonomer including at least one acid, anhydride or epoxide function is chosen from unsaturated carboxylic acid anhydrides.

7. The composition as claimed claim 1, in which the comonomer including at least one acid, anhydride, or epoxide function has an unsaturated epoxide function.

8. The composition as claimed in claim 1, in which copolymer B is free of units derived from vinyl acetate.

9. The composition as claimed in claim 1, in which the additive is chosen from inert dyes.

10. A process for manufacturing a film, comprising the extrusion of the composition as claimed in claim 1.

11. The process as claimed in claim 10, in which the extrusion is performed at a temperature of from 100 to 300° C.

12. The process as claimed in claim 10, in which the extrusion is extrusion coating or extrusion casting.

13. A film obtained via the process as claimed in claim 10.

14. The film as claimed in claim 13, having a thickness of from 2 to 100 μm.

15. The as claimed in claim 14, wherein the film is configured for use in the medical, hygiene, luggage, manufacturing, clothing, domestic or household equipment, furniture, carpet, automotive, industry, industrial filtration, agriculture and/or construction sectors.
